(19) United States
(12) Patent Application Publication
(10) Pub. No.: US 2007/0033022 A1
(43) Pub. Date: Feb. 8, 2007

(54) METHOD OF BITRATE CONTROL AND ADJUSTMENT FOR AUDIO CODING

(76) Inventors: He Ouyang, Shanghai (CN); Yi Zhou, Shanghai (CN); Binghui Wu, Shanghai (CN); Lin Luo, Shanghai (CN); Kai Wan, Shanghai (CN)

Correspondence Address: SINORICA, LLC, 528 FALLSGROVE DRIVE, ROCKVILLE, MD, 20850, US

(21) Appl. No.: 11/458,179

(22) Filed: Jul. 18, 2006

(30) Foreign Application Priority Data
Aug. 3, 2005 (CN) 200510028405.7

(51) Int. Cl. G10L 19/02

(52) U.S. Cl. 704/229

(57) ABSTRACT

This invention discloses a method of bit-rate control and adjustment for audio coding, which comprises following steps: obtain the spectrum of the current audio frame and compute the maximum absolute value of each Bark (Bark: in the unit of critical band) frequency band; calculate the initial value of the minimum scale factor threshold and set the scale factor for each Bark band; Scale the spectrum of each audio frame with different scale factor, encode the quantized spectrum and calculate the coded bit of the current frame; Determine whether or not the coded bits of current frame is within the expected range of the bits, if yes, the bitstream is formatted and outputted, otherwise the minimum scale factor threshold is adjusted and repeat the above steps until the requirement is met. This method can significantly improve the encoding speed and reduce the coding loss of audio.

### FIELD OF THE INVENTION

The present relates generally a method of audio codec, especially a method of bit control and adjustment for wideband audio coding.

### BACKGROUND OF THE INVENTION

Bit control is one of the important steps in audio coding. It is related with the bit allocation and affects the coding efficiency and compression quality eventually. Currently, iteration methods are employed to implement the bit control for the well-known wideband encoder. The objective is to approximate the expected coding bits as close as possible while preserving the audio quality. A good algorithm for bit control shall be able to fulfill this goal with the possibly small number of iteration. Consequently, the different algorithm for bit control will have a big impact on the performance of audio encoders, including encoding speed and quality loss etc. The current known bit control algorithms not only slow the encoding speed due to too much iteration but also degrade the audio quality considerably.

### SUMMARY OF THE INVENTION

The present invention provides a method of bit control and adjustment for audio coding. It can improve the encoding speed significantly and effectively reduce the audio quality loss.

To achieve the goal, the present invention comprising following steps: obtain the spectrum of the current audio frame and compute the maximum absolute value of each Bark (unit of critical band) band; calculate the initial threshold value of the minimum scale factor and set the scale factor for each Bark band; scaling the spectrum of each audio frame with different scale factor, encode the quantized spectrum and calculate the coded bits of the current frame; determine whether or not the coded bits of the current frame is within the expected range of bits, if yes, the bitstream is formatted and outputted, otherwise the minimum scale factor threshold is adjusted and repeat the above steps until the requirement is met.

The present invention deals with the Average Constant Bitrate coding. The method disclosed by this invention generally has less than 3 iterations, at most 5 to set scale factors and accomplish the fast bit control while preserving the audio quality.

### BRIEF DESCRIPTION OF THE DRAWINGS

FIG. 1 is the flow diagram which illustrates the steps to implement the method of bit control and adjustment;

FIG. 2 is the flow diagram which illustrates the steps in more detailed format;

FIG. 3 is the figure shows relation between the function F(.) and the coding bitrate;

FIG. 4 is the figure to illustrate the encoding effect by this invention, in which (a) is the specgram of the original audio signal, (b) is the specgram of the decoded audio signal and (c) is the waveform of the decoded audio signal;

FIG. 5 is the intermediate bit control data for an encoding example.

### DETAILED DESCRIPTION OF EMBODIMENTS

In the following detailed description, specific details are set forth in order to provide a thorough understanding of the invention.

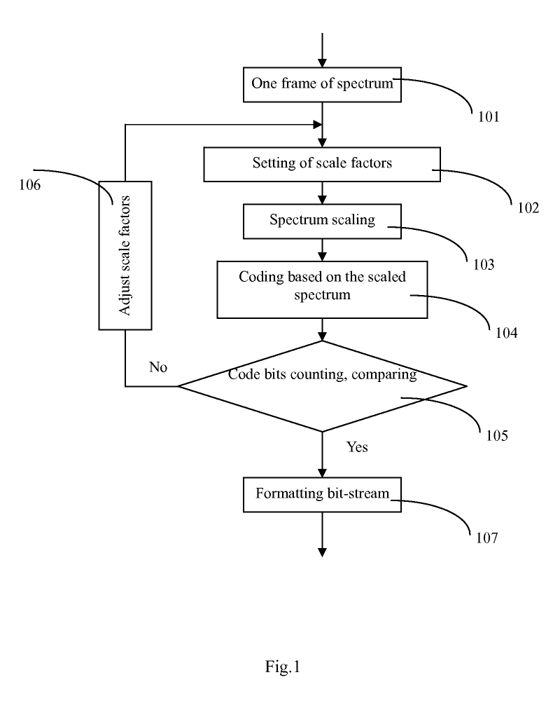

The flow given in FIG. 1 comprises the following steps:

Step 101, suppose the spectrum of each audio frame is available and the maximum absolute value of each Bark band is obtained.

Step 102, set the scale factor of each Bark band based on the maximum absolute value and the minimal threshold value of scale factor of each Bark band.

Step 103, scale the spectrum of each audio frame using the scale factor set in Step 102. The scaling is implemented based on the Bark band, all the subbands in the same Bark band use the same scale factor, and different Bark band can use different scale factor. The total coding bits depends on the coded bits of different quantized spectrum.

The scaled value of sub-bands is rounded to an integer by
S(i)*(\sqrt{2})^{Scalefactor}

in which S(i) is the absolute value the i^{th} subband and Scalefactor is the scale factor within the range of [−31, 31]. Bigger scale factor will lead to bigger quantized spectrum, equivalently, the larger coded bits; contrarily, the smaller scale factor will lead to larger quantization error, equivalently, the more quality loss. Hence, appropriately selecting the scale factor will produce the coded bite as less as possible, meanwhile preserving the audio quality.

Step 104, code the quantized spectrum and calculate the current coded bits.

Step 105, determine whether or not the coded bits of current frame is within the expected range of bits, if yes, go to step 107, format and output the bitstream, otherwise go to step 106, the minimum scale factor threshold is adjusted and repeat steps from 102 to 105 until the requirement is met.

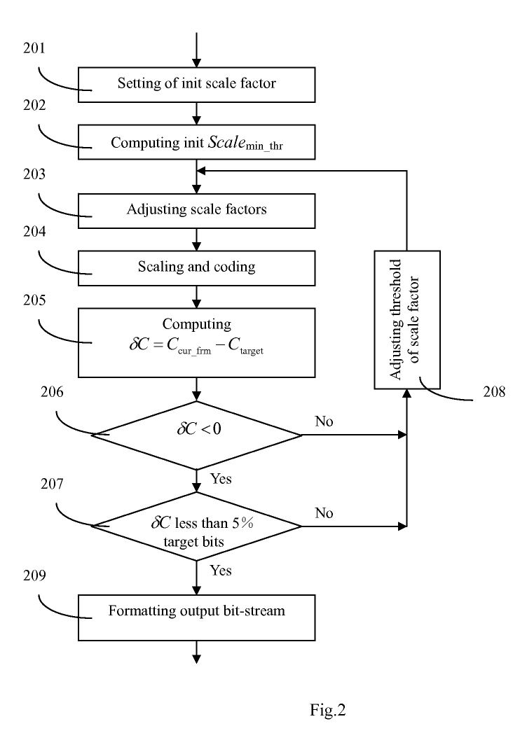

FIG. 2 describes the detailed procedures to implement the bit adjustment. In which,

Step 201, initialize the scale factor to the minimal scale factor of each Bark band. Using this scale factor, the maximum scaled value will be 1, that is, the scaled energy may exist for each quantized Bark band. If the energy of a certain Bark band is very small and the maximal energy of all the subbands is below 2⁻¹³, the initial scale factor of that Bark band is set to 25.

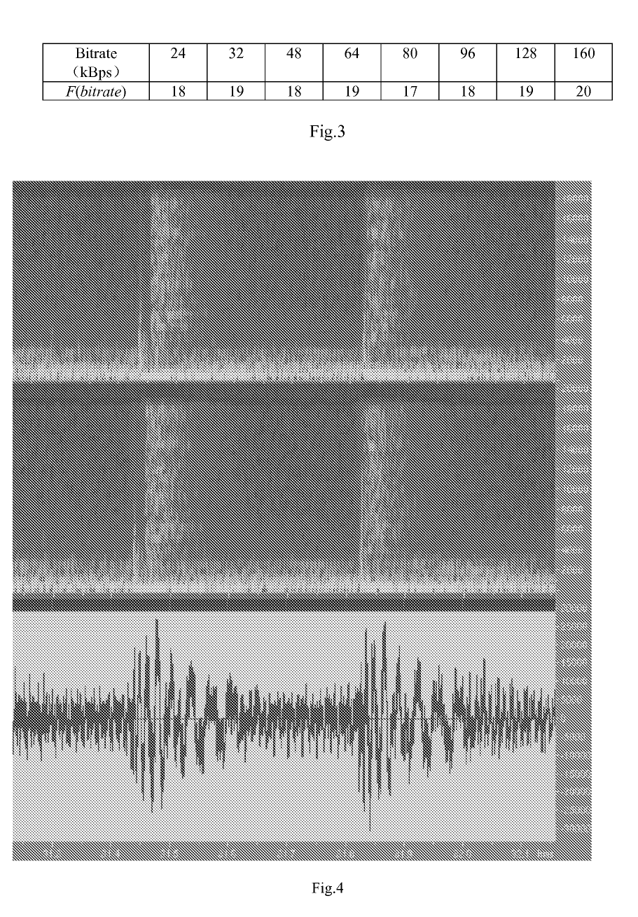

Step 202, compute the initial minimal threshold value of scale factor with the following equation:
Scaleₘᵢₙ_{_{—}}ₜₕᵣ=F(bitrate)−Bit(E)

in which the function F(.) is related with coding bitrate, and the corresponding values are given in FIG. 3. The function Bit(.) is the number of bits to represent the integer part of the total energy E with the binary form. The range of Scaleₘᵢₙ_{_{—}}ₜₕᵣ is [−31, 25] with saturation.

Step 203, adjust the minimal scale factor of each Bark band. First, taking the current minimal threshold value of scale factor Scaleₘᵢₙ_{_{—}}ₜₕᵣ as the lower limit, set all the minimal scale factors which are below Scaleₘᵢₙ_{_{—}}ₜₕᵣ to Scaleₘᵢₙ_{_{—}}ₜₕᵣ, other scale factors are kept unchanged; make the differential amplitude adjustment to the scale factor for all the Bark bands, and the variation between neighboring Bark band is below or equal to 30.

It is implemented as the three steps below: 1) from the lowest band (with Bark value 1) to the corresponding band of the highest cut-off frequency, if the scale factor Scale_{—i-1} of the neighboring higher band is 30 larger than the scale factor Scale_{—i} of the neighboring lower one, Scale_{—i+1} is set to Scale_{—i}+30, otherwise it is not changed. 2) From the corresponding band of the highest band to the lowest band (with Bark value 1), if the scale factor Scale_{—i} of the neighboring lower band is 30 larger than the scale factor Scale_{—i+1} of the neighboring higher one, Scale_{—i} is set to Scale_{—i+1}+30, otherwise it is not changed. 3) if the minimal scale factor Scale_{—}ₘᵢₙ is above Scaleₘᵢₙ_{_{—thr}}, all the scale factors will subtract (Scale_{—min}−Scaleₘᵢₙ_{_{—}}ₜₕᵣ).

Step 204, scale the spectrum, code the quantized spectrum and calculate the current coded bits.

Step 205, Compare the current coded bits with the expected coding bits with the following equation
δC=C_{cur}_{_{—}}_{frm}−C_{target}.

Step 206, if the result of Step 205 is above 0, go to Step 209, format and output the bitstream; otherwise go to Step 208, adjust the minimal threshold value of scale factor and repeat the steps from 203 to 205.

Step 207, if the result of Step 205 is larger than 95% of the expected coding bits, go to Step 209, format and output the bitstream; otherwise go to Step 208, adjust the minimal threshold value of scale factor and repeat the steps from 203 to 205.

Step 208, adjust the minimal threshold value of scale factor. It may handle the following two cases:
If the coded bits using the initial minimal threshold value of scale factor is less than the expected coding bits, the minimal threshold value will increased by 1 in the next iteration of bite adjustment. The setting of scale factors, scaling and encoding steps are repeated until the coded bits exceeds the expected, and take the bitstream produced by the last iteration as the final coded bitstream; In addition, there are two conditions to terminate the iteration: 1) the minimal scale factor is above or equal to 25; 2) the bitrate is larger than 95% of the expect coding bits. Under these two cases, the bitstream produced by the current scale factor is the final coded bitstream.

If the coded bit using the initial minimal threshold value of scale factor is more than the expected coding bits, the minimal threshold value will decreased by 1 in the next iteration of bit adjustment. The setting of scale factors, scaling and encoding steps are repeated until the coded bits is smaller than the expected, and take the bitstream produced by the current iteration as the final coded bitstream.

FIG. 3 gives the correspondence between the function F(.) and the bitrate.

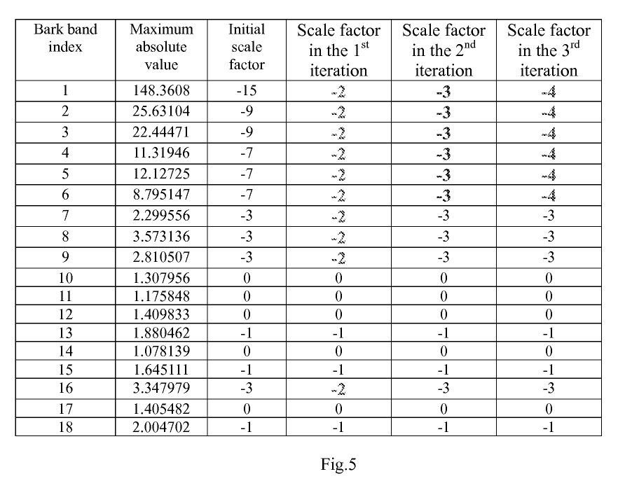

FIG. 4 is the figure to illustrate the encoding result by this invention, in which (a) is the specgram of the original audio signal, (b) is the specgram of the decoded audio signal and (c) is the waveform of the decoded audio signal. We can see that the spectrum of decoded signals matches the original very well.

FIG. 5 lists the scale factors in the iterative process. In this example, the bit control is accomplished after 3 iterations. “Maximum absolute value” lists the maximum absolute value of each Bark band obtained in Step 101. “Initial scale factor” is computed in Step 201. “Scale factor in the 1^{st} iteration”, “Scale factor in the 2^{nd} iteration” and “Scale factor in the 3^{rd} iteration”, obtained in Step 206, exact scale factors in each iteration process are listed in this figure.

This invention is associated with high-quality low-complexity wideband audio codec. It deals with the average constant bit-rate. This invention is a method of bit control and it is a fast implementation algorithm as well, it can effectively reduce the number of iterations, meanwhile significantly improved coding efficiency.

What is claimed is:

1. A method of bit-rate control and adjustment for audio coding, comprising following steps:
obtain spectrum of current audio frame and compute maximum absolute value of each Bark frequency band;
calculate initial value of minimum scale factor threshold and set the scale factor for each Bark frequency band;
Scale the spectrum of each audio frame with different scale factor, encode quantized spectrum and calculate coded bits of current frame;
Determine whether or not the coded bits of the current frame is expected range of bits, if yes, bitstream is formatted and outputted, otherwise the minimum scale factor threshold is adjusted and repeat above steps until requirement is met.

2. The method as described in claim 1, wherein the said set the scale factor for each Bark frequency band shall be carried out by following procedure: scale each sub-band with corresponding minimal scale factor, and maximum value of quantized output is 1; If energy of a certain Bark frequency band is very small and maximum energy of all sub-bands is below 2⁻¹³, initial scale factor of frequency band is set to 25.

3. The method as described in claim 1, wherein said scale the spectrum of each audio frame with different scale factor shall be carried out by following procedure: the quantized value of frequency sub-bands is derived in expression below and rounded to an integer,
S(i)*(\sqrt{2})^{Scalefactor}
in which S(i) is absolute value of i^{th} subband, Scalefactor is scale factor within range of [−31, 31].

4. The method as described in claim 1, wherein said calculate the initial value of the minimum scale factor threshold shall be carried out by following procedure: based on total spectrum energy E of corresponding frame and the minimal scale factor threshold, obtained coding bit-rate by calculating with following equation,
Scaleₘᵢₙ_{_{—}}ₜₕᵣ=F(bitrate)−Bit(E)
in which function F(.) is related with coding bit-rate, and the range of Scaleₘᵢₙ_{_{—}}ₜₕᵣ is [−31, 25].

5. The method as described in claim 1, wherein said set the scale factor for each Bark frequency band shall be carried out by following procedure:
taking current minimal scale factor threshold Scaleₘᵢₙ_{_{—}}ₜₕᵣ as lower limit, set all the minimal scale factors which are below Scaleₘᵢₙ_{_{—}}ₜₕᵣ to Scaleₘᵢₙ_{_{—}}ₜₕᵣ, other scale factors are kept unchanged;
make differential amplitude adjustment to the scale factor for all the Bark bands, and variation between successive Bark band is below or equal to 30.

6. The method as described in claim 1 or 5, wherein said adjustment to scale factors further comprises following procedure:
from lowest band with Bark value 1 to corresponding band of highest cut-off frequency, if scale factor Scale_{—i+1} of neighboring higher band is 30 larger than scale factor Scale_{—i} of neighboring lower one, Scale_{—i+1} is set to Scale_{—i+30}, otherwise it is not changed;
From corresponding band of the highest band to lowest band with Bark value 1, if the scale factor Scale_{—i} of the neighboring lower band is 30 larger than the scale factor Scale_{—i+1} of the neighboring higher one, Scale_i is set to Scale_{—i+1}+30, otherwise it is not changed;
After the above two steps, if minimal quantization factor Scale_{—min} is above Scaleₘᵢₙ_{_{—}}ₜₕᵣ, all the quantization factors will subtract (Scale_{—min}−Scaleₘᵢₙ_{_{—}}ₜₕᵣ).

7. The method as described in claim 1 or 5, wherein said the adjustment to the minimal scale factor further comprises following procedure:
if the coded bits with the initial minimal threshold value of scale factor is less than expected, the minimal threshold value will increased by 1 in next iteration of bit adjustment; Setting of scale factors, scaling and encoding steps are repeated until the coded bits exceeds expect, and take the bitstream produced by the last iteration as the final coded bitstream;
if the minimal scale factor is above 25 and the coded bits is larger than 95% of the expect, the bitstream produced by current scale factor is taken as final coded bitstream.

8. The method as described in claim 1 or 5, wherein said adjustment to the minimal scale factor further comprises following procedure: if the coded bits with the initial minimal threshold value of scale factor is more than expected, the minimal threshold value will decreased by 1 in next iteration of bit adjustment; Setting of scale factors, scaling and encoding steps are repeated until the coded bits is smaller than expect one, and take the bit-stream produced by current iteration as final coded bit-stream.

9. The method as described in claim 1, wherein said determine whether or not the coded bits of the current frame is expected range of the bits shall employ the following equation:
δC=C_{cur}_{_{—}}_{frm}−C_{target}.
